(19) United States
(12) Patent Application Publication
(10) Pub. No.: US 2021/0207687 A1
(43) Pub. Date: Jul. 8, 2021

(54) Transmission for a Motor Vehicle

(71) Applicant: ZF Friedrichshafen AG, Friedrichshafen (DE)

(72) Inventors: Stefan Beck, Eriskirch (DE); Martin Brehmer, Tettnang (DE); Matthias Horn, Tettnang (DE); Kim Führer, Lindau (DE); Andreas Geiger, Markdorf (DE); Thomas Riedisser, Lindau (DE)

(21) Appl. No.: 15/777,376

(22) PCT Filed: Nov. 10, 2016
(86) PCT No.: PCT/EP2016/077336

§ 371 Date: May 18, 2018

(30) Foreign Application Priority Data
Nov. 30, 2015 (DE) 10 2015 223 728.1

(51) Int. Cl. F16H 3/66; B60K 6/365

(52) U.S. Cl. CPC F16H 3/66; B60K 6/48; B60K 6/365

(57) ABSTRACT

A transmission (G) for a motor vehicle includes an input shaft (GW1), an output shaft (GW2), an electric motor (EM) which is configured for driving the input shaft (GW1) and is operable as a generator, a plurality of planetary gear sets (P1, P2, P3), and a plurality of shift elements (03, 04, 05, 14, 15). By selectively engaging the shift elements (03, 04, 05, 14, 15), various forward gears (1 to 6) between the input shaft (GW1) and the output shaft (GW2) are formable. A first shift element (04) contributes only to forming the first of the forward gears (1 to 6). By engaging the first shift element (04), a carrier (E21) of one of the planetary gear sets (P1, P2, P3) is rotationally fixable. The first shift element (04) is a friction-locking frictional shift element, friction faces of which have no friction lining and have the same surface property.

### FIELD OF THE INVENTION

The invention relates generally to a transmission for a motor vehicle.

### BACKGROUND

Patent application US 2012/0178573 A1 describes a transmission including an input element, an output element, three planetary gear sets, and a plurality of torque transmission units. The input element is connected to an input shaft of the transmission via a damper and a clutch. An electric motor is connected to the input shaft. The gear set structure on which this transmission is based is described in patent application DE 199 12 480 A1.

The shortest forward ratio which can be obtained with this transmission can be obtained by engaging the torque transmission units marked as 68 and 66. In the case of a high input-shaft torque, the torque transmission unit marked as 66 undergoes a high torque load. When the torque transmission unit marked as 66 is designed as a lamellar shift element which is usual in automatic transmissions and is formed from disks including friction lining and steel disks arranged in alternation, attention must be paid to the permissible contact pressure of the friction linings in the case of such a high load. A lamellar shift element designed in this way must therefore be designed having a large diameter and a large number of disks. However, this increases the design complexity of the transmission as well as its outer dimensions, and results in elevated drag torques.

The shift element marked as 66 is not required for forming the further forward ratios. In the case of upshifts, this shift element is therefore only disengaged, but not engaged. The teaching of patent application DE 102 44 023 A1 is to design shift elements which only disengage during upshifts as form-fit shift elements. A form-fit shift element includes no friction linings which limit the contact pressure, and can be designed having a small effective diameter. A disengagement and an engagement of such a shift element is possible only in the largely load-free condition, however. This restricts the power shiftability of the transmission.

In a transmission including an electric machine which is configured for driving the motor vehicle when operated as a motor and for braking the motor vehicle when operated as a generator, a coasting downshift to the first forward gear is advantageous in order to make the best use of the generator operating mode. This is the case because, as a result, the electric machine can be operated at a high speed for as long as possible. If the shift element to be engaged only in the first forward gear is designed as a form-fit shift element, such a coasting downshift cannot be carried out under load without special measures. As a cure, in these types of transmissions, a coasting downshift into the first forward gear can be omitted. Remaining in the second forward gear during coasting results in frequent traction downshifts from the second forward gear into the first forward gear, however, for example when the motor vehicle is to be accelerated again from a slowly rolling condition. In the case of an engaging form-fit shift element, such a gear change operation can result in a worsening of the shifting comfort

Patent application DE 10 2009 001 101 A1 teaches the use of frictional shift elements having a higher permissible contact pressure in the case of shift elements which are disengaged in traction upshifts in order to form a ratio. However, this patent application provides no guidelines for making a selection in the case of highly loaded shift elements which are to be engaged in traction downshifts.

### SUMMARY OF THE INVENTION

In this case, a transmission means, in particular, a multi-stage transmission, in which a multitude of gears, i.e., fixed transmission ratios between two shafts of the transmission, are preferably automatically shiftable by shift elements. In this case, the shift elements are clutches or brakes, for example. Such transmissions are utilized primarily in motor vehicles in order to adapt the rotational speed and torque output characteristic of the drive unit to the driving resistances of the vehicle in a suitable way.

Example aspects of the invention provide a motor vehicle transmission including an electric machine or motor, which includes a shift element which is highly loaded in the first forward gear, wherein the construction of the shift element promotes a compact design of the transmission accompanied by low drag losses, and which can be engaged under load in a traction downshift.

The transmission includes an input shaft, an output shaft, an electric machine or motor, a plurality of planetary gear sets, and a plurality of shift elements. The electric machine is configured for driving the input shaft in the motor operating mode and for drawing power from the input shaft in the generator operating mode. By selective engagement of the shift elements, various forward gears can be formed between the input shaft and the output shaft.

The shift elements include a first shift element which contributes only to forming the first of the forward gears. The first shift element can also contribute to forming a reverse gear between the input shaft and the output shaft. By engaging this first shift element, a carrier of one of the planetary gear sets is rotationally fixable. The first shift element therefore operates as a brake. Since the carrier in a planetary gear set designed as a negative or minus gear set forms the total shaft of the planetary gear set, the torque to be supported on the carrier is greater than on other elements of the planetary gear set, for example the sun gear.

According to the invention, the first shift element is designed as a friction-locking frictional shift element, the disks of which exclusively include non-lined friction faces. In other words, the disk-shaped base body of each disk of the frictional shift element includes no friction lining applied to the disk. The friction faces of individual disks or all disks of such a frictional shift element can be heat-treated, however, for example nitrided. These types of frictional shift elements are largely unsuitable for a controlled slip operation. Nevertheless, an engagement under load and differential speed is non-destructively possible. Since the friction faces include no friction lining, a considerably greater contact pressure is possible than is the case with conventional lamellar shift elements, whereby the number of disks and the frictional surface can be reduced. As a result, the drag torques in the disengaged condition of the first shift element can be reduced.

In the case of a traction downshift, the disengaging shift element is transferred to a slip operation in order to increase the rotational speed of the input shaft to the desired level. Once the specified rotational speed has been reached, the engaging shift element is engaged. In the specific case, the first shift element is the engaging shift element. The selection of a frictional shift element without a friction lining allows for engagement, in this case, even in the case of deviations from the specified rotational speed, i.e., in slip operation. In contrast to a form-fit shift element, the first shift element designed according to the invention is less sensitive to inaccuracies in the rotational speed detection and to the inertia of the engagement actuators. The ease of gear changes can therefore be improved.

Preferably, the friction elements of the first shift element are designed as steel disks without lining These types of friction elements are simple to manufacture and have a high permissible contact pressure.

According to one preferred embodiment, the shift elements of the transmission include a second shift element which operates as a brake and is designed as a friction-locking frictional shift element including multiple inner clutch disks and multiple outer clutch disks. In this second shift element, the surface property of the friction faces of the inner clutch disks differs from the surface property of the friction faces of the outer clutch disks. For example, the inner clutch disks are designed as disks including friction lining, while the outer clutch disks are designed as bright steel disks. This second shift element can be provided as a shift element engaging from the first forward gear into the second forward gear.

If the first shift element is hydraulically actuatable by a piston, this piston can enclose a rotationally fixed body, at least in sections. This rotationally fixed body is preferably configured as a rotationally fixed interface of the second shift element in this case. A particularly compact design therefore results.

The rotationally fixed body, which acts as a rotationally fixed interface of the second shift element, is configured for rotationally fixing the outer clutch disks of the second shift element. The outer clutch disks are displaceable in the axial direction in this case. Furthermore, the rotationally fixed body is configured for supporting the force acting on the second shift element by an actuating piston. The rotationally fixed body therefore performs several functions, whereby a compact design of the transmission is facilitated.

Preferably, the rotationally fixed body can act as an interface to a thrust bearing, wherein the thrust bearing is configured for supporting forces acting in the axial direction between the planetary gear sets and a housing of the transmission. The rotationally fixed body is connected to the housing for this purpose, and is therefore arranged in the load path of these forces between the planetary gear sets and the housing. The rotationally fixed body therefore performs several functions, whereby a compact design of the transmission is facilitated Preferably, the thrust hearing is arranged radially within the second shift element.

Preferably, the first shift element is arranged directly on the housing of the transmission, wherein an oil feed to the first shift element radially from the outside is provided. The oil feed is utilized primarily for lubricating the first shift element. An oil feed designed in this way facilitates the oil feed proceeding from a transmission hydraulic system arranged on the edge of the housing. This also facilitates a compact design of the transmission.

A gear set design, which is particularly suitable for the transmission according to the invention, is described in the following. In this case, the transmission includes three planetary gear sets, each one including a first element, a second element, and a third element. The first element is always formed by the sun gear of the respective planetary gear set. In a design as a negative or minus gear set, the second element is formed by the carrier of the respective planetary gear set, and the third element is formed by the ring gear of the respective planetary gear set. In a design as a positive or plus gear set, the second element is formed by the ring gear of the respective planetary gear set, and the third element is formed by the carrier of the respective planetary gear set.

The second element of the first planetary gear set is permanently connected to the third element of the second planetary gear set. The second element of the second planetary gear set is permanently connected to the third element of the third planetary gear set. The third element of the first planetary gear set is permanently connected to the second element of the third planetary gear set and to the output shaft. The first element of the second planetary gear set is permanently connected to the input shaft or is connectable to the input shaft via one of the shift elements.

By engaging the first shift element, the second element of the first planetary gear set, which is designed as a minus gear set, is rotationally fixable. By engaging the second shift element, the first element of the first planetary gear set is rotationally fixable. The shift elements include a third shift element, by way of the engagement of which the first element of the third planetary gear set is rotationally fixable.

Advantageously, the shift elements include a fourth shift element and a fifth shift element. By engaging the fourth shift element, the second element of the first planetary gear set is connectable to the input shaft. By engaging the fifth shift element, the first element of the first planetary gear set is connectable to the first element of the second planetary gear set.

A permanent connection is referred to as a connection that always exists between two elements. Elements which are permanently connected in such a way always rotate with the same dependence between their speeds. There can be no shift element located in a permanent connection between two elements. A permanent connection is therefore to be distinguished from a shiftable connection. A permanently rotationally fixed connection is referred to as a connection that always exists between two elements and, therefore, the connected elements in the connection always have the same rotational speed.

The expression “engage a shift element” in the context of gear formation is understood to mean an operation in which the shift element is controlled in such a way that the shift element transmits a high amount of torque at the end of the engagement operation. While form-fit shift elements do not permit a speed differential in the “engaged” state, in the case of friction-locking shift elements in the “engaged” state, a low speed differential can form between the shift-element halves, either intentionally or not.

### BRIEF DESCRIPTION OF THE DRAWINGS

Exemplary embodiments of the invention are described in detail in the following with reference to the attached figures. Wherein:

FIG. 1 shows a schematic representation of one exemplary embodiment of a transmission according to the invention,

FIG. 2 shows a shift pattern; and

FIG. 3 shows a cutaway view of one structural embodiment of the transmission.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

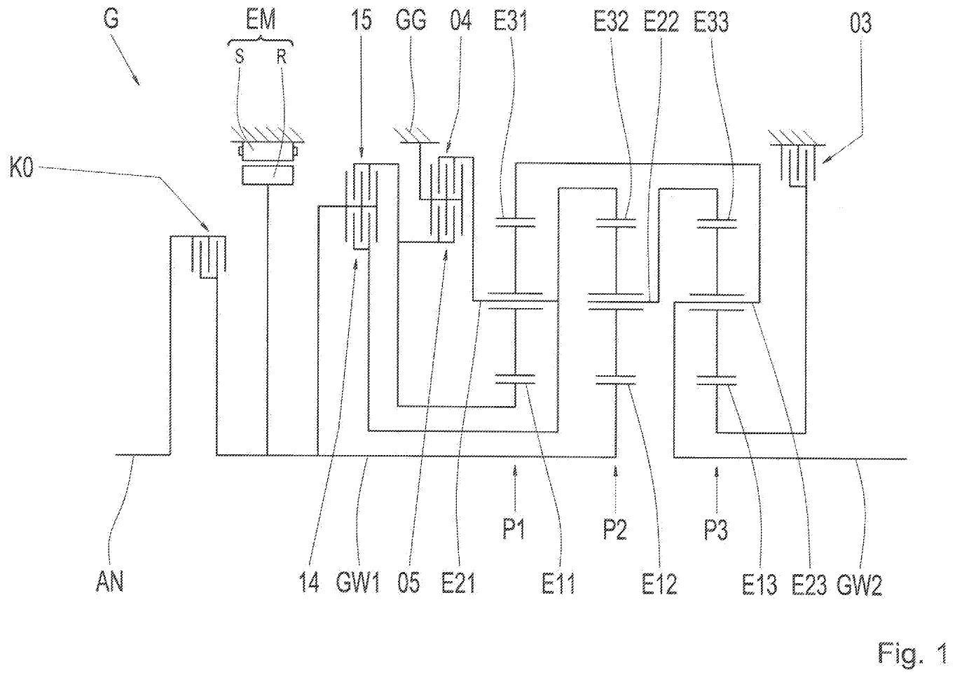

FIG. 1 schematically shows a transmission G according to one exemplary embodiment of the invention. The transmission G includes a first planetary gear set P1, a second planetary gear set P2, a third planetary gear set P3, an input shaft GW1, an output shaft GW2, an electric machine or motor EM including a rotationally fixed stator S and a rotary rotor R, as well as a first shift element 04, a second shift element 05, a third shift element 03, a fourth shift element 14, and a fifth shift element 15. The three planetary gear sets P1, P2, P3 are each designed as a negative or minus gear set and each include a first element E11, E12, E13, a second element E21, E22, E23, and a third element E31, E32, E33. The first element E11, E12, E13 is always formed by a sun gear of the respective planetary gear set. In the case of a planetary gear set designed as a negative or minus gear set, the second element E21, E22, E23 is designed as a carrier of the respective planetary gear set and the third element E31, E32, E33 is designed as a ring gear of the respective planetary gear set. In the case of a planetary gear set designed as a positive or plus gear set, the assignment of the elements “carrier” and “ring gear” to the second element and the third element is to be interchanged.

The input shaft GW1 is permanently connected to the first element E12 of the second planetary gear set P2. The output shaft GW2 is permanently connected to the second element E23 of the third planetary gear set P3 and to the third element E31 of the first planetary gear set P1. The second element E21 of the first planetary gear set P1 is permanently connected to the third element E32 of the second planetary gear set P2. The second element E22 of the second planetary gear set P2 is permanently connected to the third element E33 of the third planetary gear set P3.

By engaging the first shift element 04, the second element E21 of the first planetary gear set P1 is rotationally fixable, in that it is connected to a rotationally fixed component GG of the transmission G. By engaging the second shift element 05, the first element E11 of the first planetary gear set P1 is rotationally fixable in the same way. By engaging the third shift element 03, the first element E13 of the third planetary gear set P3 is rotationally fixable in the same way. The shift elements 04, 05, 03 therefore operate as brakes.

By engaging the fourth shift element 14, the input shaft GW1 is connectable to the second element E21 of the first planetary gear set P1. By engaging the fifth shift element 15, the first element E11 of the first planetary gear set P1 is connectable to the first element E12 of the second planetary gear set P2. The fourth and the fifth shift elements 14, 15 therefore operate as clutches.

The rotor R of the electric machine EM is permanently connected to the input shaft GW1, whereby the electric machine EM is configured for driving the input shaft GW1 or for drawing power therefrom. The transmission G further includes a connecting shaft AN, to which a transmission-external drive unit can be connected. The connecting shaft AN is connectable to the input shaft GW1 via a separating clutch K0. When the separating clutch K0 is disengaged, the electric machine EM is configured for driving the output shaft GW2, in an engaged gear of the transmission G, without reacting on the connecting shaft AN and the transmission-external drive unit connected thereto.

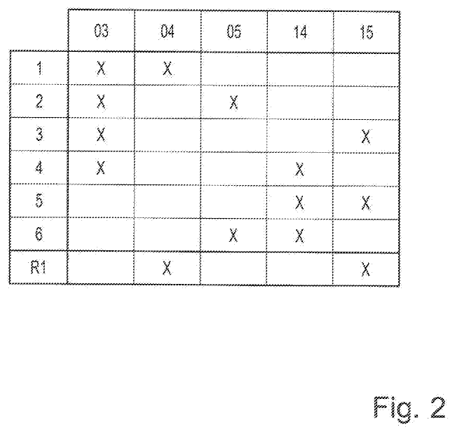

FIG. 2 shows a shift pattern which can be applied for the transmission G according to FIG. 1. Six forward gears 1 to 6 and one reverse gear R1 are indicated in the rows of the shift pattern. In the columns of the shift pattern, an X indicates which of the shift elements 03, 04, 05, 14, 15 is engaged in which forward gear 1 to 6, and in the reverse gear R1. In this case, the first shift element 04 contributes to forming one of the forward gears 1 to 6 only in the first forward gear 1. In the reverse gear R1, the first shift element 04 is also engaged. The second shift element 05 is engaged in the second forward gear 2 and in the sixth forward gear 6. In all other forward gears 1 to 6, the second shift element 05 is disengaged.

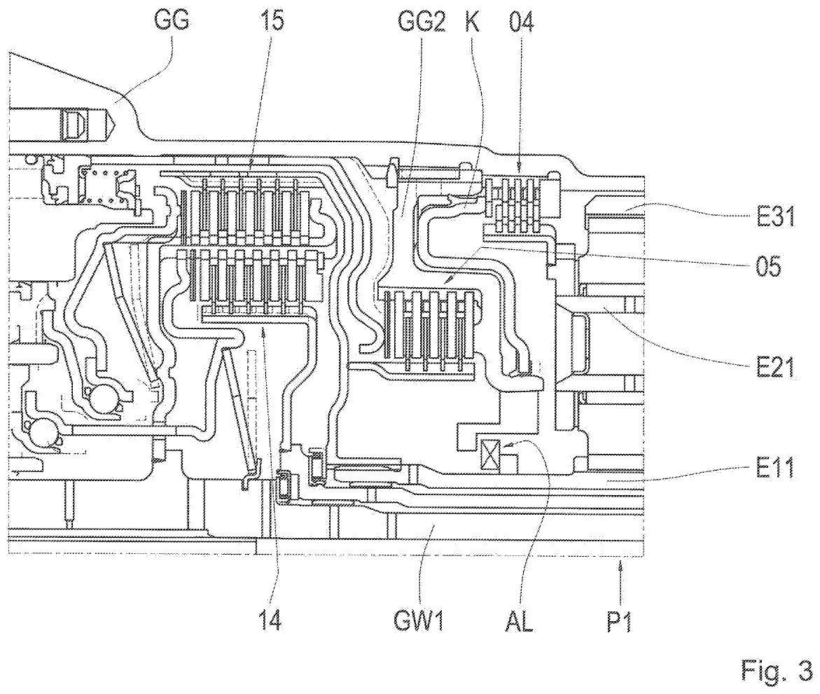

FIG. 3 shows a cutaway view of one structural embodiment of the transmission, wherein only one portion of the transmission G is represented. In this cutaway view, it is clearly apparent that the second shift element 05 is designed as a friction-locking frictional shift element, the inner clutch disks of which include friction linings and the outer clutch disks of which include no friction linings. The first shift element 04 is also designed as a friction-locking frictional shift element, wherein the frictional surface of the first shift element 04 is considerably smaller as compared to the frictional surface of the second shift element 05, despite the greater effective diameter. In the cutaway view, it is also clearly apparent that the disks of the first shift element 04 include no friction lining. The inner disk carrier of the first shift element 04 is permanently connected to the second element E21 of the first planetary gear set P1 in this case. The outer disk carrier of the first shift element 04 is permanently connected to the transmission housing GG. In this case, an oil feed to the first shift element 04 radially from the outside, proceeding from the transmission housing GG, is provided; this is not represented in the representational cutting plane.

The first shift element 04 is hydraulically actuatable by a piston K. In this case, the piston K surrounds a rotationally fixed body GG2, at least in sections. The rotationally fixed body GG2 is permanently connected to the transmission housing GG. Furthermore, the rotationally fixed body GG2 acts as an outer disk carrier of the second shift element 05. The inner disk carrier of the second shift element 05 is permanently connected to the first element E11 of the first planetary gear set P1. The rotationally fixed body GG2 acts as a rotationally fixed interface of the second shift element 05. The second shift element 05 is also hydraulically actuatable by yet another piston, wherein the axial forces acting on the second shift element 05 by the actuating piston are supported by the rotationally fixed body GG2.

A thrust bearing AL is provided radially within the second shift element 05. The thrust bearing AL is configured for supporting forces acting in the axial direction between the planetary gear sets P1, P2, P3 and the transmission housing GG of the transmission G.

Modifications and variations can be made to the embodiments illustrated or described herein without departing from the scope and spirit of the invention as set forth in the appended claims.

### REFERENCE CHARACTERS

G transmission
GG transmission housing
GG2 rotationally fixed body
P1 first planetary gear set
E11 first element of the first planetary gear set
E21 second element of the first planetary gear set
E31 third element of the first planetary gear set
P2 second planetary gear set
E12 first element of the second planetary gear set
E22 second element of the second planetary gear set
E32 third element of the second planetary gear set
P3 third planetary gear set
E13 first element of the third planetary gear set
E23 second element of the third planetary gear set
E33 third element of the third planetary gear set
03 third shift element
04 first shift element
05 second shift element
14 fourth shift element
15 fifth shift element
GW1 input shaft
GW2 output shaft
EM electric machine
S stator
R rotor
1 to 6 forward gears
R1 reverse gear
K piston
AL thrust bearing
An connecting shaft
K0 separating clutch

1-10: (canceled)

11. A transmission (G) for a motor vehicle, comprising:
an input shaft (GW1);
an output shaft (GW2);
an electric motor configured for driving the input shaft (GW1), the electric motor operable as a generator;
a plurality of planetary gear sets (P1, P2, P3); and
a plurality of shift elements (03, 04, 05, 14, 15),
wherein
a plurality of forward gears (1 to 6) between the input shaft (GW1) and the output shaft (GW2) are formable by selectively engaging the shift elements (03, 04, 05, 14, 15),
the shift elements (03, 04, 05, 14, 15) include a first shift element (04) which contributes only to forming a first forward gear of the plurality of forward gears (1 to 6),
a carrier (E21) of one of the planetary gear sets (P1, P2, P3) is rotationally fixable by engaging the first shift element (04), and
the first shift element (04) is a friction-locking frictional shift element, and disks of the first shift element (04) have only non-lined friction faces.

12. The transmission (G) of claim 11, wherein the disks of the first shift element (04) are steel disks without lining.

13. The transmission (G) of claim 11, wherein:
the shift elements (03, 04, 05, 14, 15) include a second shift element (05) which is a brake and is a friction-locking frictional shift element,
the second shift element (05) comprises a plurality of inner clutch disks and a plurality of outer clutch disks, and
a surface property of friction faces of the inner clutch disks differs from a surface property of friction faces of the outer clutch disks.

14. The transmission (G) of claim 13, wherein the first shift element (04) is hydraulically actuatable by a piston (K), the piston (K) at least in part radially surrounds a rotationally fixed body (GG2), and the rotationally fixed body (GG2) is configured as a rotationally fixed interface of the second shift element (05).

15. The transmission (G) of claim 14, wherein the rotationally fixed body (GG2) rotationally fixes the outer clutch disks of the second shift element (05) and is further configured for supporting a force acting on the second shift element (05) by an actuating piston.

16. The transmission (G) of claim 14, wherein the rotationally fixed body (GG2) acts as an interface of a thrust bearing (AL), the thrust bearing (AL) is configured for supporting forces acting in an axial direction between the planetary gear sets (P1, P2, P3) and a transmission housing (GG) of the transmission (G).

17. The transmission (G) of claim 16, wherein the thrust bearing (AL) is arranged radially within the second shift element (05).

18. The transmission (G) of claim 11, wherein the first shift element (04) is arranged directly on the housing (GG) of the transmission (G), and a radially inward oil feed is flowable to the first shift element (04).

19. The transmission (G) of claim 13, wherein:
the planetary gear sets (P1, P2, P3) comprise a first planetary gear set (P1), a second planetary gear set (P2) and a third planetary gear set (P3), each of the planetary gear sets (P1, P2, P3) comprises a first element (E11, E12, E13), a second element (E21, E22, E23), and a third element (E31, E32, E33), the first element (E11, E12, E13) being a sun gear of the respective planetary gear set (P1, P2, P3), the second element (E21, E22, E23) being a carrier of the respective planetary gear set (P1, P2, P3) when the respective planetary gear set (P1, P2, P3) is a minus gear set, the second element (E21, E22, E23) being a ring gear of the respective planetary gear set (P1, P2, P3) when the respective planetary gear set (P1, P2, P3) is a plus gear set, the third element (E31, E32, E33) being the ring gear of the respective planetary gear set (P1, P2, P3) when the respective planetary gear set (P1, P2, P3) is the minus gear set, the second element (E21, E22, E23) being the carrier of the respective planetary gear set (P1, P2, P3) when the respective planetary gear set (P1, P2, P3) is the plus gear set;
the first planetary gear set (P1) is the minus gear set, and the second element (E21) of the first planetary gear set (P1) is permanently connected to the third element (E32) of the second planetary gear set (P2);
the second element (E22) of the second planetary gear set (P2) is permanently connected to the third element (E33) of the third planetary gear set (P3);
the third element (E31) of the first planetary gear set (P1) is permanently connected to the second element (E23) of the third planetary gear set (P3) and to the output shaft (GW2);
the first element (E12) of the second planetary gear set (P2) is permanently connected to the input shaft (GW1) or is connectable to the input shaft (GW1) via one of the shift elements;
the second element (E21) of the first planetary gear set (P1) is rotationally fixable by engaging the first shift element (04);
the first element (E11) of the first planetary gear set (P1) is rotationally fixable by engaging the second shift element (05); and
the shift elements (03, 04, 05, 14, 15) include a third shift element (03), the first element (E13) of the third planetary gear set (P3) rotationally fixable by engaging the third shift element (03).

20. The transmission (G) of claim 19, wherein;
the shift elements (03, 04, 05, 14, 15) include a fourth shift element (14), the second element (E21) of the first planetary gear set (P1) connectable to the input shaft (GW1) by engaging the fourth shift element (14); and
the shift element (03, 04, 05, 14, 15) include a fifth shift element (15), the first element (E11) of the first planetary gear set (P1) connectable to the first element (E12) of the second planetary gear set (P2) by engaging the fifth shift element (15).
